(19) United States
(12) Patent Application Publication
(10) Pub. No.: US 2024/0002285 A1
(43) Pub. Date: Jan. 4, 2024

(54) Graphene Based Phobic Coating on Carbon

(71) Applicant: AKHAN Semiconductor, Inc., Gurnee, IL (US)

(72) Inventors: Adam Khan, San Francisco, CA (US); Ernest Schirmann, Lake Zurich, IL (US)

(21) Appl. No.: 18/467,962

(22) Filed: Sep. 15, 2023

Related U.S. Application Data
(63) Continuation of application No. 17/980,963, filed on Nov. 4, 2022, now abandoned.
Application No. 17/980,963 is a continuation of application No. 16/932,620, filed on Jul. 17, 2020, now abandoned.
(60) Provisional application No. 62/875,170, filed on Jul. 17, 2019.

(51) Int. Cl. C03C 17/36

(52) U.S. Cl. CPC C03C 17/3634; C03C 17/3649; C03C 2217/28; C03C 2217/76; C03C 2218/153; C03C 2218/32; C03C 2218/156

(57) ABSTRACT

Disclosed herein is method for fabricating a graphene layer on a non-graphene carbon layer including steps of cleaning and seeding a substrate, depositing a crystalline diamond on the substrate, sputtering an aluminum layer on the crystalline diamond, where the aluminum layer is greater than 5 nanometers and less than 50 nanometers; and treating a surface of the aluminum layer with an ion beam resulting in a graphene layer on the crystalline diamond.

### CROSS-REFERENCE TO RELATED APPLICATIONS

This application is a continuation of U.S. patent application Ser. No. 17/980,963, filed Nov. 4, 2022, which is a continuation of U.S. patent application Ser. No. 16/932,620, filed Jul. 17, 2020, which claims the benefit of U.S. Provisional Application Ser. No. 62/875,170, filed Jul. 17, 2019. All of the foregoing are hereby incorporated by reference in their entirety.

### FIELD

This invention is generally related to graphene coatings, and more particularly to a system and method for graphene based hydrophobic and oleophobic coatings on carbon substrates.

### BACKGROUND

Graphene Coatings are used in a number of applications, including those related to optics and surface protection. Graphene coating technology includes that disclosed, for example, in U.S. Pat. Publ. 2015/0206748, published Jul. 23, 2015, by Sumant and Berman. Prior art graphene coatings systems and methods do not include a practical method and system for graphene based hydrophobic and oleophobic coatings on carbon substrates.

### SUMMARY

Disclosed herein is a new and improved system and method for graphene coatings. In accordance with one aspect of the approach, a method of fabricating a graphene layer on a non-graphene carbon layer comprising steps of cleaning and seeding a substrate, depositing a crystalline diamond on the substrate, sputtering an aluminum layer on the crystalline diamond, where the aluminum layer is greater than 5 nanometers and less than 50 nanometers; and treating a surface of the aluminum layer with an ion beam resulting in a graphene layer on the crystalline diamond.

Other systems, methods, aspects, features, embodiments and advantages of the system and method disclosed herein will be, or will become, apparent to one having ordinary skill in the art upon examination of the following drawings and detailed description. It is intended that all such additional systems, methods, aspects, features, embodiments and advantages be included within this description, and be within the scope of the accompanying claims.

### BRIEF DESCRIPTION OF THE DRAWINGS

It is to be understood that the drawings are solely for purpose, of illustration. Furthermore, the components in the figures are not necessarily to scale, emphasis instead being placed upon illustrating the principles of the system disclosed herein. In the figures, like reference numerals designate corresponding parts throughout the different views.

FIG. 1 is a diamond and graphene structure.

FIG. 2 is an intermediate diamond and graphene structure that may be created during the fabrication of the diamond and graphene structure of FIG. 1.

FIG. 3 is a block diagram of an embodiment of a method for fabricating a diamond and graphene structure, such as the diamond and graphene structure of FIG. 1.

FIG. 4 is a diamond graphene metal structure.

FIG. 5 is a first intermediate diamond graphene metal structure that may be created during the fabrication of the diamond and graphene structure of FIG. 4.

FIG. 6 is a second intermediate diamond graphene metal structure that may be created during the fabrication of the diamond and graphene structure of FIG. 4.

FIG. 7 is a block diagram of an embodiment of a method 700 for fabricating a diamond graphene metal structure, such as the diamond graphene metal structure of FIG. 4.

FIG. 8 is a diamond and graphene oxide structure.

FIG. 9 is, a first intermediate diamond and graphene oxide structure that may be created during the fabrication of the diamond and graphene structure of FIG. 8.

FIG. 10 is a second intermediate diamond and graphene oxide structure that may be created during the fabrication of the diamond and graphene structure of FIG. 8.

FIG. 11 is a block diagram of an embodiment of a method 1100 for fabricating a diamond and graphene oxide structure, such as the diamond and graphene oxide structure of FIG. 8.

FIG. 12 is a diamond and fluorinated grapheme oxide structure.

FIG. 13 is an intermediate diamond and fluorinated graphene oxide structure that may be created during the fabrication of the diamond and fluorinated graphene structure of FIG. 12.

FIG. 14 is a block diagram of an embodiment of a method for fabricating a diamond and fluorinated graphene oxide structure, such as the diamond and fluorinated graphene oxide structure 1200 of FIG. 12.

### DETAILED DESCRIPTION

The following detailed description, which references to and incorporates the drawings, describes and illustrates one or more specific embodiments. These embodiments, offered not to limit but only to exemplify and teach, are shown and described in sufficient detail to enable those skilled in the art to practice what is claimed. Thus, for the sake of brevity, the description may omit certain information known to those of skill in the art.

Disclosed herein are several exemplary diamond and graphene structures (100, 400, 800, 1200), several methods for fabricating those diamond and graphene structures (300, 700, 1100, 1400), and several intermediate structures created during the fabrication process (200, 500, 600, 900, 1000, 1300).

FIG. 1 shows an exemplary diamond and graphene structure 100 including a substrate 102, a diamond layer 104 and a graphene layer 106. Substrate 102 may be, but is not limited to, Silicon, Silicon Dioxide, and glasses. The substrate 102 glasses may include, but are not limited to, BK7 and modified and/or strengthened glass such as Aluminosilicate glass. Substrate 102 may be, but is not limited to, a thickness of 500 micro-meters. Diamond layer 104 may be a number of carbon materials, but is not limited to, single crystal diamond, polycrystalline diamond, nanocrystalline diamond, microcrystalline diamond, and, diamond like carbon. Diamond layer 104 may be, but is not limited to, a thickness of 150 nanometers and thicknesses of 5 nanometers through 500 nanometers. Graphene layer 106 may be, but is not limited to, a thickness of 50-100 nanometers.

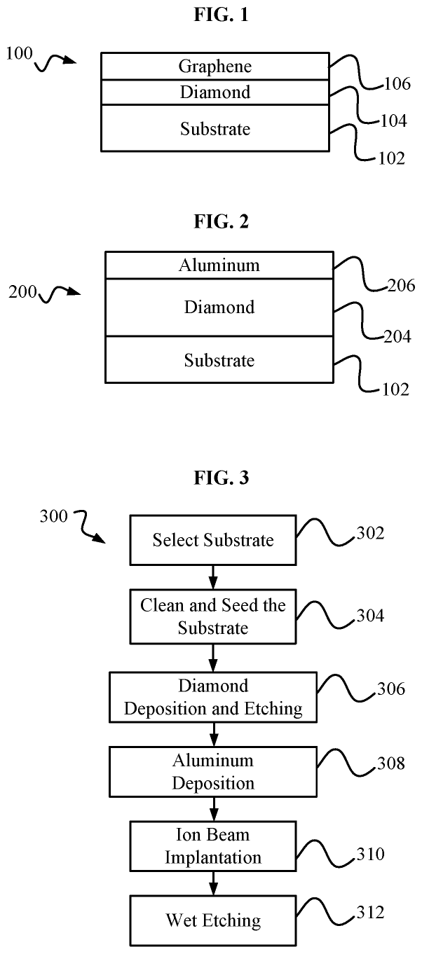

FIG. 2 shows an exemplary intermediate diamond and graphene structure 200 including a substrate 102, an intermediate diamond layer 204 and an Aluminum layer 206. Intermediate diamond layer 204 may be, but is not limited to, nanocrystalline diamond. Intermediate diamond layer 204 may be, but is not limited to, a thickness of 350 nanometers and thicknesses of 5 nanometers through 500 nanometers. Aluminum layer 206 may be, but is not limited to, a thickness of 30 nanometers and thicknesses between 4 and 100 nanometers.

FIG. 3 shows an exemplary block diagram of an embodiment of a method 300 for fabricating a diamond and graphene structure, such as, but not limited to, diamond and graphene structure 100. Method 300 may include a step 302 of selecting a substrate, such as, but not limited to substrate 102. Method 300 may include a step 304 of cleaning and seeding the substrate of step 302. Step 304 may include exposing the substrate to an acid cleaning mixture. Step 304 may include seeding with a nano-diamond seed solution mixture. Step 304 may include ultrasonicating on an alcohol solution to promote nucleation and film agglomeration

Step 306 may include diamond deposition and etching. The deposition may be a chemical vapor deposition and may include exposing the substrate to a methane, argon, and hydrogen plasma gas mixture to produce a thin nanocrystalline diamond film. Step 306 may also include reactive ion etching to control overgrowth. The reactive ion etching may include etching using an argon and oxygen mixture. Step 306 may produce a bulk planarized uniform diamond film. Step 306 may include the use of a hot filament and a microwave plasma system.

Step 308 may include aluminum deposition. The Aluminum deposition may include a physical deposition, such as, but not limited to sputtering physical vapor deposition. Step 308 may include loading the substrate into a magnetron sputtering vapor deposition system. Step 308 may produce an aluminum layer, such as, but not limited to Aluminum layer 206. Step 308 may include an ion milling process in the event of overgrowth.

Step 310 may include ion beam implantation. The ion beam implantation may include using dopants such as, but not limited to, Nitrogen, Oxygen, Phosphorus, Sulfur, Boron and Gallium. Step 308 may be performed with an ion beam of low energy, for example 60 eV, and high concentration, for example 10.sup.21 through 10.sup.23 per cubic centimeter. Step 312 may include wet etching, for example, Aluminum layer 206, may be wet etched. The result of method 300 may be a diamond and graphene structure, such as, but not limited to diamond and graphene structure 100

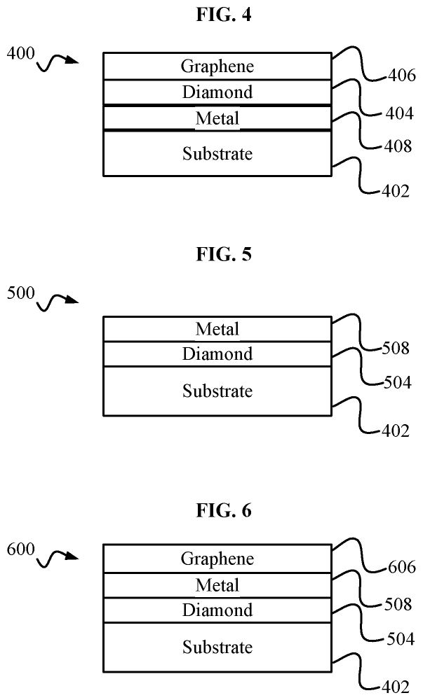

FIG. 4 shows an exemplary diamond graphene metal structure 400 including a substrate 402, a metal layer 408, a diamond, layer 404 and a graphene layer 406. Substrate 402 may be, but is not limited to, a substrate such as substrate 102. Diamond layer 404, may be, but is not limited to, a diamond layer such as diamond layer 104. Graphene layer 406 may be, but is not limited to, grapheme layer 106. Metal layer 408 may be, but is not limited to, high purity iron, zinc, copper, cobalt, nickel, or a combination of such elements. Metal layer 408 may be, but is not limited to, a thickness of 15-30 nanometers and may be within a range of 3 nanometers to 50 nanometers.

FIG. 5 shows an exemplary first intermediate diamond graphene metal structure 500 including a substrate 402, a first intermediate diamond layer 504 and a first intermediate metal layer 508. First intermediate diamond layer 504 may be, but is not limited to, nanocrystalline diamond. First intermediate diamond layer 504 may be, but is not limited to, a thickness of 150 nanometers and thicknesses of 100 nanometers through 1000 nanometers. First intermediate metal layer 50$ may be, but is not limited to, a thickness of 30 nanometers and thicknesses between 3 and 65 nanometers.

FIG. 6 shows an exemplary second intermediate diamond graphene metal structure 600 including the substrate 402, the first intermediate diamond layer 504, the first intermediate metal layer 508, and an intermediate graphene layer 606. First intermediate graphene layer 606 may be, but is not limited to, a thickness in a range from 50-100 nanometers.

FIG. 7 shows an exemplary block diagram of an embodiment of a method 700 for fabricating a diamond graphene metal structure, such as, but not limited to, diamond graphene metal structure 400. Method 700 may include a step 702 of selecting a substrate, such as, but not limited to substrate 102. Method 700 may include a step 704 of cleaning and seeding the substrate of step 702. Step 704 may include steps such as those of step 304 of method 300. Method 700 may include a step 706 of deposition an etching. Step 706 may include steps such as those of step 306 of method 300.

Method 700 may include a metal deposition step 708. The metal deposition may include a physical deposition, such as, but not limited to, sputtering physical vapor deposition. Step 708 may include steps similar to step 308 of method 300. Step 708 may produce a metal layer, such as, but not limited to metal layer 508. Step 708 may include Nickel deposition using Atomic Layer Deposition (ALD) and/or magnetron sputtering. In some embodiments, Copper and/or Cobalt may be deposited with Iron. Step 708 may include an ion milling process in the event of overgrowth. The result of step 708 may a system such as, but not limited to first intermediate diamond graphene metal structure 500.

Method 700 may include a graphene deposition step 710. In step 710, graphene may be deposited on top of a metal layer, such as, but not limited to, metal layer 508. Step 710 may include the use of a chemical vapor deposition system. The result of step 710 may a system such as, hut not limited to second intermediate diamond graphene metal structure 600.

Method 700 may include an annealing step 712. Step 712 may include annealing a system, such as structure 600, inside a chemical vapor deposition system, and/or using Rapid Thermal Annealing (RTA). RTA may be performed at 800-1000 degrees Celcius, for 40-60 seconds, in an Ar/H.sub.2 environment. Annealing may cause some, or all, of a metal layer, such as metal layer 508, to migrate below a diamond layer, such as diamond layer 504. The result of step 712 may be a system, such as, but not limited to diamond graphene metal structure 400.

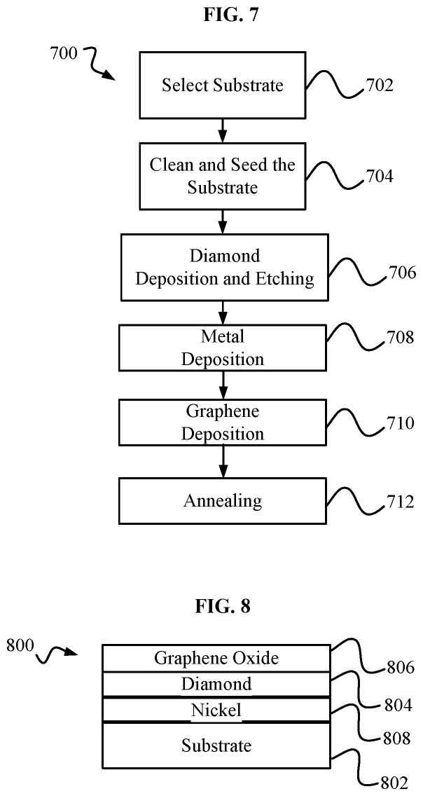

FIG. 8 shows an exemplary diamond and graphene oxide structure 800 including a substrate 802, a Nickel layer 808, a diamond layer 804 and a graphene layer 806. Substrate 802 may be, but is not limited to, a substrate such as substrate 102. Diamond layer 804, may be, hut is not limited to, a diamond layer such as diamond layer 104. Graphene oxide layer 406 may be, but is not limited to, a thickness of 50-100 nanometers.

FIG. 9 shows an exemplary first intermediate diamond and graphene oxide structure 900 including a substrate 402, a first intermediate diamond layer 504, and a first intermediate Nickel layer 908. First intermediate Nickel layer 908 may be, but is not limited to, a thickness of 30 nanometers and thicknesses between 3 and 65 nanometers. Structure 900 may include a graphene oxide on nanocrystalline diamond with a graphene oxide/NCD interface.

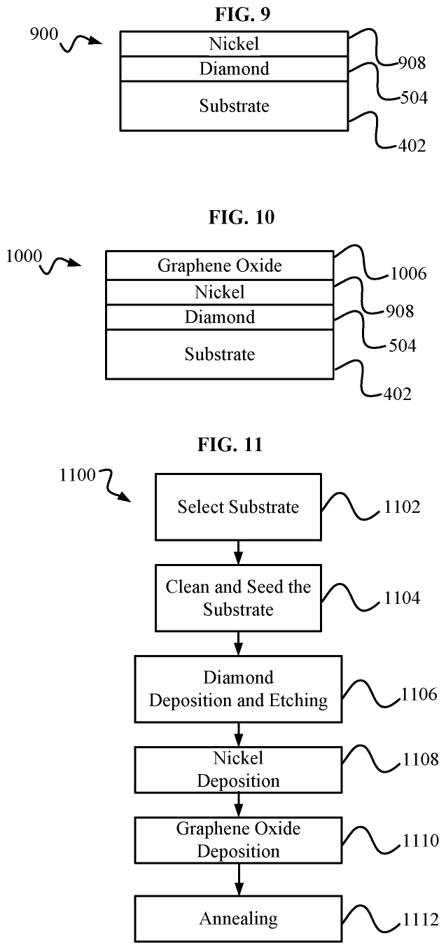

FIG. 10 shows an exemplary second intermediate diamond and graphene oxide structure 1000 including the substrate 402, the first intermediate diamond layer 504, the first intermediate nickel layer 908, and an intermediate graphene oxide layer 1006. First intermediate graphene oxide layer 1006 may be, but is not limited to, a thickness in a range from 50-100 nanometers.

FIG. 11 shows an exemplary block diagram of an embodiment of a method 1100 for fabricating a diamond and graphene oxide structure, such as, but not limited to, diamond and graphene oxide structure 800. Method 1100 may include a step 1102 of selecting a substrate, such as, but not limited to substrate 102. Method 1100 may include a step 1104 of cleaning and seeding the substrate of step 1102. Step 1104 may include steps such as those of step 304 of method 300. Method 1100 may include a step 1106 of diamond deposition and etching. Step 1106 may include steps such as those of step 306 of method 300.

Method 1100 may include a Nickel deposition step 1108. Step 1108 may produce a Nickel layer, such as, but not limited to Nickel layer 908. Step 1108 may include Nickel deposition using ALD and/or magnetron sputtering, The result of step 1108 may a system such as, but not limited to first intermediate diamond and graphene oxide structure 900. In some embodiments, Iron, copper, Cobalt and/or Zinc, or combinations of such elements, may be used in place of, or with Nickel.

Method 1100 may include a graphene oxide deposition step 1110. In step 1110, graphene oxide may be deposited on top of a metal layer, such as, but not limited to, Nickel layer 908. Step 1110 may include the use of a chemical vapor deposition system. Step 1110 may include the use of Plasma Enhanced Chemical Vapor Deposition (PECVD). The result of step 1110 may a system such as, but not limited to second intermediate diamond and graphene oxide structure 1000.

Method 1100 may include an annealing step 1112. Step 1112 may include annealing a system, such as structure 1000, inside a chemical vapor deposition system, and/or using Rapid Thermal Annealing (RTA). RTA may be performed similarly to that described in step 712. Annealing may cause some or all of a metal layer, such as Nickel layer 908, to migrate below a diamond layer, such as diamond layer 504. The result of step 1112 may a system such as, but not limited to diamond and graphene oxide structure 800.

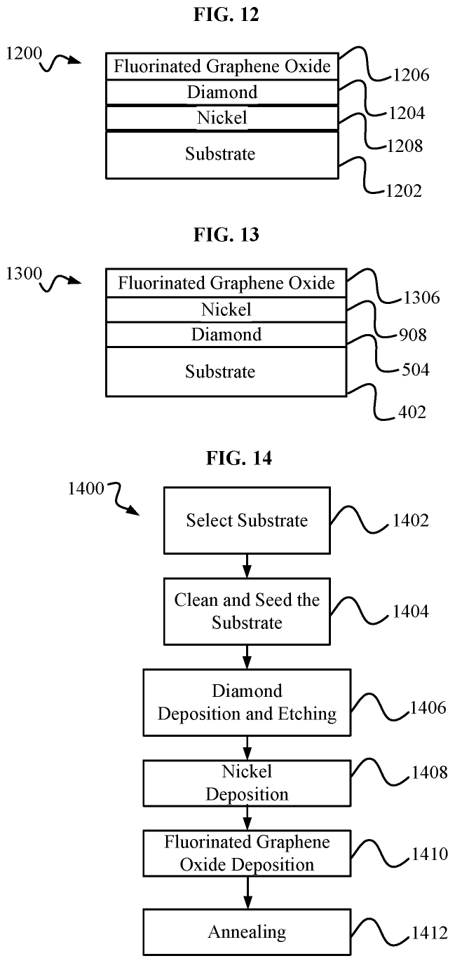

FIG. 12 shows an exemplary diamond and fluorinated graphene oxide structure 1200 including a substrate 1202, a Nickel layer 1208, a diamond layer 1204 and a fluorinated graphene oxide layer 1206. Substrate 1202 may be, but is not limited to, a substrate such as substrate 102. Nickel layer may be, but is not limited to, a Nickel layer such as Nickel layer 808.

Diamond layer 1204, may be, but is not limited to, a diamond layer such as diamond layer 104. Fluorinated graphene oxide layer 1206 may be, but is not limited to, a thickness of 10-100 nanometers.

FIG. 13 shows an exemplary intermediate diamond and fluorine graphene oxide structure 1300 including the substrate 402, the first intermediate diamond layer 504, the first intermediate nickel layer 908, and an intermediate fluorinated graphene oxide layer 1306. The intermediate fluorinated graphene oxide layer 1306 may be, but is not limited to, a thickness in a range from 50-100 nanometers.

FIG. 14 shows an exemplary block diagram of an embodiment of a method 1400 for fabricating a diamond and fluorinated graphene oxide structure, such as, but not limited to, diamond and fluorinated graphene oxide structure 1200. Method 1400 may include a step 1402 of selecting a substrate, such as, but not limited to substrate 102. Method 1400 may include a step 1404 of cleaning and seeding the substrate of step 1402. Step 1404 may include steps such as those of step 304 of method 300. Method 1400 may include a step 1406 of diamond deposition and etching. Step 1406 may include steps such as those of step 306 of method 300.

Method 1400 may include a Nickel deposition step 1408. Step 1408 may produce a Nickel layer, such as, but not limited to Nickel layer 908. Step 1408 may include steps such as those of step 1108 of method 1100. The result of step 1408 may a system such as, but not limited to first intermediate diamond and graphene oxide structure 900.

Method 1400 may include a fluorinated graphene oxide deposition step 1410. In step 1410, fluorinated graphene oxide may be deposited on top of a metal layer, such as, but not limited to, Nickel layer 908. Step 1410 may include the use of a chemical vapor deposition system. Step 1410 may include the use of PECVD where graphene oxide is grown in a fluorine gas environment. The result of step 1410 may a system such as, but not limited to intermediate diamond and fluorinated graphene oxide structure 1300.

Method 1400 may include an annealing step 1412. Step 1412 may include annealing a system, such as structure 1300, inside a chemical vapor deposition system, and/or using RTA. RTA may be performed similarly to that described in step 712. Annealing may cause some, or all, of a metal layer, such as Nickel layer 908, to migrate below a diamond layer, such as diamond layer 504. The result of step 1412 may a system such as, but not limited to diamond and fluorinated graphene oxide structure 1200.

The systems and methods described herein may incorporate systems and methods previously disclosed and described in U.S. Patent Publication No. 2013/0026492, by Adam Khan, published on Jan. 31, 2013; U.S. Pat. No. 8,354,290, issued to Anirudha Sumant, et al, on Jan. 15, 2013; U.S. Pat. No. 8,933,462, issued to Adam Khan, on Jan. 13, 2015; U.S. Patent Publication No. 2015/0206749, by Adam Khan, published on Jul. 23, 2015; and U.S. Patent Publication No. 2015/0295134, by Adam Khan, et al, published on Oct. 15, 2015, all of which are fully incorporated herein by reference.

This disclosure provides several preferred embodiments of fabrication, however, the performance characteristics and materials characteristics described in this application are not necessarily performance bounds or limitations of the invention. These disclosures merely demonstrate some aspects of the invention that have presently been tested.

The word “exemplary” is used herein to mean “serving as an example, instance, or illustration.” Any embodiment or variant described herein as “exemplary” is not necessarily to be construed as preferred or advantageous over other embodiments or variants. All of the embodiments and variants described in this description are exemplary embodiments and variants provided to enable persons skilled in the art to make and use the invention, and not necessarily to limit the scope of legal protection afforded the appended claims.

The above description of the disclosed embodiments is provided to enable any person skilled in the art to make or use that which is defined by the appended claims. The following claims are not intended to be limited to the disclosed embodiments. Other embodiments and modifications will readily occur to those of ordinary skill in the art in view of these teachings.

Therefore, the following claims are intended to cover all such embodiments and modifications when viewed in conjunction with the above specification and accompanying drawings.

1. A method of fabricating a graphene layer comprising:
cleaning and seeding a substrate;
depositing crystalline diamond on the substrate;
sputtering an aluminum layer on the crystalline diamond, where the aluminum layer is greater than 5 nanometers and less than 50 nanometers; and
treating a surface of the aluminum layer with an ion beam damaging an interface between the aluminum layer and the crystalline diamond and converting the aluminum layer into the graphene layer on the crystalline diamond.
